(19) United States
(12) Patent Application Publication
(10) Pub. No.: US 2025/0326008 A1
(43) Pub. Date: Oct. 23, 2025

(54) APPARATUS AND METHODS FOR THE REMOVAL OF IMPURITIES FROM CARBON NANOMATERIALS

(71) Applicant: Trimtabs Ltd, Swansea (GB)

(72) Inventors: Alvin ORBAEK WHITE, Swansea (GB); David J. RYAN, Swansea (GB); Thomas A. MAHY, Bridgend (GB)

(21) Appl. No.: 19/182,971

(22) Filed: Apr. 18, 2025

Related U.S. Application Data
(60) Provisional application No. 63/636,576, filed on Apr. 19, 2024.

(51) Int. Cl. B08B 3/00; B08B 5/00; B08B 13/00; C01B 32/17

(52) U.S. Cl. CPC B08B 3/00; B08B 5/00; B08B 13/00; C01B 32/17; B08B 2230/01; C01P 2006/80

(57) ABSTRACT

The present disclosure relates to an apparatus for producing high purity carbon nanotubes (CNTs) and related carbon allotropes and carbon nanomaterials with low metallic content. Moreover, this apparatus disclosed herein lends additional purification to such materials by the removal of amorphous carbon or other coke from the final material. In some embodiments, an apparatus for cleaning carbon nanomaterials includes a steam generation unit configured to provide steam via a gas line at a flow rate of about 0.001 L/min to about 10 L/min. The apparatus further includes a gas supply unit configured to provide a process gas to the gas line at a flow rate of about 0.001 L/min to about 15 L/min. The apparatus further comprises a purification/reaction unit including a reaction vessel. The apparatus further includes an exhaust gas cleaning unit.

### CROSS-REFERENCE TO RELATED APPLICATIONS

This application claims benefit of U.S. provisional patent application Ser. No. 63/636,576, filed Apr. 19, 2024, which is herein incorporated by reference in its entirety.

### BACKGROUND

### Field

The present disclosure relates to an apparatus for producing high-purity carbon nanotubes (CNTs) and related carbon allotropes and carbon nanomaterials with low metallic content. Moreover, this apparatus described herein lends additional purification to such materials by the removal of amorphous carbon or other coke from the produced material.

### Description of Related Art

The present disclosure relates to the use of a high-pressure apparatus to encase carbon nanotubes (CNTs) and other carbon nanomaterials for treatment at high pressure and temperature using various chemical means, including but not limited to, the use of halogens such as chlorine. The apparatus can be used regardless of the size of the individual nanomaterials, or the nature and type of the nanomaterials, be they single-walled carbon nanotubes, multi-walled carbon nanotubes, carbon fibers, vapor-grown fibers, or Buckminster fullerene molecules. In particular, the present disclosure relates to an apparatus that may be operated either in a dry process, or a wet process, and the nanomaterials can be used in a purified or non-purified form. The present disclosure is not limited to carbon nanotubes but can be applied to carbon fibers, vapor-grown carbon fibers, graphene, nanoribbons, carbon nanofibers, and Buckminsterfullerenes.

Carbon nanotubes are a generic term for a wide range of materials typically having a tubular structure. Carbon nanotube compounds are malleable and can be molded and pressed into a variety of shapes according to the housing in which they are applied. Carbon nanotubes are both considered an inorganic and an organic polymer-like material, typically having high molecular mass and often contain end-caps that are either of Buckminster fullerene shape, or containing the residual catalyst material from whence they were formed. Carbon nanotubes are usually synthetic and derived from petrochemicals, plastics, and other carbon materials.

A variety of carbon allotropes of nanomaterials include graphene, multi-walled carbon nanotubes, single-walled carbon nanotubes, and buckminsterfullerene. Both single-walled carbon nanotubes (SWCNTs) and multi-walled carbon nanotubes (MWCNTs) are cylindrical materials in which the crystallographic lattice remains unbroken throughout the tube lengths.

The use of carbon nanotubes and carbon nanomaterials is not typically widespread yet, mainly due to the high purchase price of CNT materials. Yet, such materials are extremely stable and offer the potential for use in a wide variety of applications. Carbon nanotubes and carbon nanomaterials that have been space-hardened exhibit high-strength and lightweight properties, which offer many advantages over traditional materials and metals such as copper, aluminum, or compositions/composites having a blend of materials. However, it is often challenging to compose these carbon nanomaterials into macro-scale apparatus, such as energy storage apparatus, because they contain remnants of the catalyst from which they were produced. For this reason, carbon nanomaterials are typically cleaned of the residual catalyst materials or made with catalyst materials that are not deleterious to applications in energy storage industries. The choice of catalyst can influence the quality of the nanotubes, and the most common catalysts are from the transition metal series of iron, cobalt, or nickel. However, using these catalysts can deleteriously influence the charge-discharge properties of batteries and supercapacitors. Thus, a low quantity, or entire absence of residual catalyst, is desired. Furthermore, for applications in composites, residual metal remnants can cause issues with polymer binding and may reduce the build quality of composites. In medical applications, it is undesirable to have residual metal particles as they may be toxic, especially in the treatment of at-risk patients with compromised immune systems, such as cancer patients. Therefore, in many cases, a reduced quantity of metal is advantageous for numerous applications and industries.

Of the various conventional methods to produce pristine nanotubes and other carbon nanomaterials, it is common for the materials to be exposed to a liquid treatment of an acidic medium. This implies that carbon nanotubes are wetted and then thoroughly cleaned using water. However, water is an ever increasingly scarce resource, and so the present technologies relying on water treatment will likely contribute to water shortages.

A drawback of conventional carbon nanomaterial treatment processes is that carbon nanomaterial treatment cannot be done at scale or in an automatic fashion using robotics. Accordingly, the scale of application is limited, which hinders the widespread commercial adoption and application of these valuable materials.

### SUMMARY

The present disclosure relates to an apparatus for producing high-purity carbon nanotubes (CNTs) and related carbon allotropes and nanomaterials with low metallic content. Moreover, the apparatus disclosed herein enables additional purification to such materials by the removal of amorphous carbon or other coke from the final material.

In some embodiments, an apparatus for cleaning carbon nanomaterials includes a steam generation unit configured to provide steam via a gas line at a flow rate of about 0.001 L/min to about 10 L/min. The apparatus further includes a gas supply unit configured to provide a process gas to the gas line at a flow rate of about 0.001 L/min to about 15 L/min. The apparatus also includes a purification/reaction unit including a reaction vessel. The purification/reaction unit is coupled with the gas line to flow the steam and the process gas through the reaction vessel. The reaction vessel is removably coupled with purification/reaction unit. The reaction vessel includes an outer shell, a chemical-resistant interior, and a felt filter element. The apparatus further includes an exhaust gas cleaning unit.

In some embodiments, an apparatus for cleaning carbon nanomaterials includes a steam generation unit configured to provide steam via a gas line at a temperature of about 100° C. to about 1200° C. The apparatus includes a gas supply unit configured to provide a process gas to the gas line at an operating pressure of about 5 barg or less. The apparatus further includes a purification/reaction unit including a reaction vessel. The purification/reaction unit is coupled with the gas line to flow the steam and the process gas through the reaction vessel. The reaction vessel is removably coupled with purification/reaction unit. The reaction vessel includes an outer shell, a chemical-resistant interior, and a felt filter element. The apparatus further includes an exhaust gas cleaning unit. The apparatus further includes a controller. The controller is configured to execute a process. The process includes executing a system blowdown operation to remove contaminants from the apparatus. The process further includes introducing carbon nanomaterials to the reaction vessel. The carbon nanomaterials include an impurity. The process further includes initiating operation of the steam generation unit to provide a steam to the reaction vessel. The process further includes initiating operation of the gas supply unit to provide a process gas to the reaction vessel. The process gas includes chlorine gas. The process further includes initiating operation of the purification/reaction unit to flow the steam and the process gas through the reaction vessel to form a complex between the impurity and the chlorine gas. The complex is soluble in an aqueous environment.

In some embodiments, an apparatus for cleaning carbon nanomaterials includes a purification/reaction unit. The purification/reaction unit includes a removable reaction vessel. The removable reaction vessel includes an outer shell, a chemical-resistant interior, and a felt filter element. The apparatus further includes a steam generation unit coupled to the purification/reaction unit via a gas line configured to flow a gas through the removable reaction vessel. The apparatus further includes a gas supply unit coupled to the purification/reaction unit via the gas line. The apparatus further includes an exhaust cleaning unit coupled to the purification/reaction unit.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a process flow diagram depicting a process, according to an embodiment described herein.

FIG. 2 is a process flow diagram depicting a process, according to an embodiment described herein.

FIG. 3 is a schematic, cross-sectional diagram of an apparatus, according to an embodiment described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure relates to an apparatus for producing high-purity carbon nanotubes (CNTs) and related carbon allotropes and carbon nanomaterials with no metallic content, a de minimus amount of metallic content, or an appreciably small amount of metallic content which does not deleteriously impact subsequent utilization or performance of the carbon material. The present disclosure relates to an apparatus that enables the formation of carbon nanotubes having less than 1 wt % of residual catalyst iron content. Moreover, this apparatus enables additional purification of the carbon nanomaterials by facilitating the removal of amorphous carbon or other coke from the final material. Accordingly, the electrical, mechanical, and biological properties of carbon nanomaterials produced by the apparatus described herein are improved as a consequence of the unique aspects of and processes enabled by this apparatus.

The present disclosure describes a method for preparing electrically conductive carbon nanotubes and other carbon nanomaterials. The method involves the use of a unique apparatus design to house raw carbon nanotubes, which is implemented in a system configured to remove the spent catalyst material, such as iron.

The apparatus includes two units, a portafilter unit and a housing unit in which the portafilter resides. The portafilter controls the steam and gas delivery to clean the carbon nanotubes.

The present disclosure includes a purification apparatus designed for the removal of iron impurities from carbon nanomaterials (e.g., carbon nanotubes (CNTs)). The apparatus includes a purification chamber seal (e.g., reaction vessel 302) and locking mechanism (e.g., removable locking mechanism 310) that rotates into place to hermetically seal a purification chamber, which enables maintenance of desirable internal conditions during purification processes. Inside the chamber, filter elements enable the passage of process gasses therethrough while securely containing the carbon nanomaterials, facilitating both retention and gas exchange during the purification process. The chamber is lined with a chemical-resistant graphite material, which provides durability and longevity of the apparatus while remaining substantially inert during exposure to corrosive substances. A metallic exterior casing of the chamber provides structural strength and containment of process gasses and effluent, which enables suitable environmental protection. Carbon nanomaterials are loaded in the purification chamber and processed to remove iron within this sealed environment. A process gas pump (e.g., pump 322) circulates gasses through the filters, and the system includes a containment vessel (e.g., containment vessel 236) for collecting an impurity laden condensate. The purified contents are then directed through a drain and drain valve (e.g., valve 202n) system for safe disposal into a liquid holding tank (e.g., collection tank 238), completing the purification cycle. The construction and operational workflow highlight the apparatus' innovative approach to ensuring high-efficiency and safety in CNT purification.

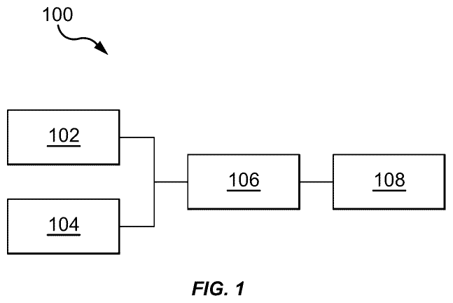

The present disclosure relates to an integrated system 100 (shown in FIG. 1) designed for the purification of carbon nanotubes (CNTs), which may include other types of morphologies of carbon nanomaterials, using a combination of steam and reactive gas processes. The integrated system 100 may include four primary components, such as a steam generation unit 102, a gas supply unit 104, a purification/reaction unit 106, and an exhaust cleaning unit 108. In some embodiments, the steam generation unit 102 and/or the gas supply unit 104 is fluidly coupled with the purification/reaction unit 106. In at least one embodiment, the purification/reaction unit 106 is fluidly coupled with the exhaust cleaning unit 108. Each of the components of the integrated system 100 may be configured to execute specific functions to enable purification of CNTs and safe handling of process gasses.

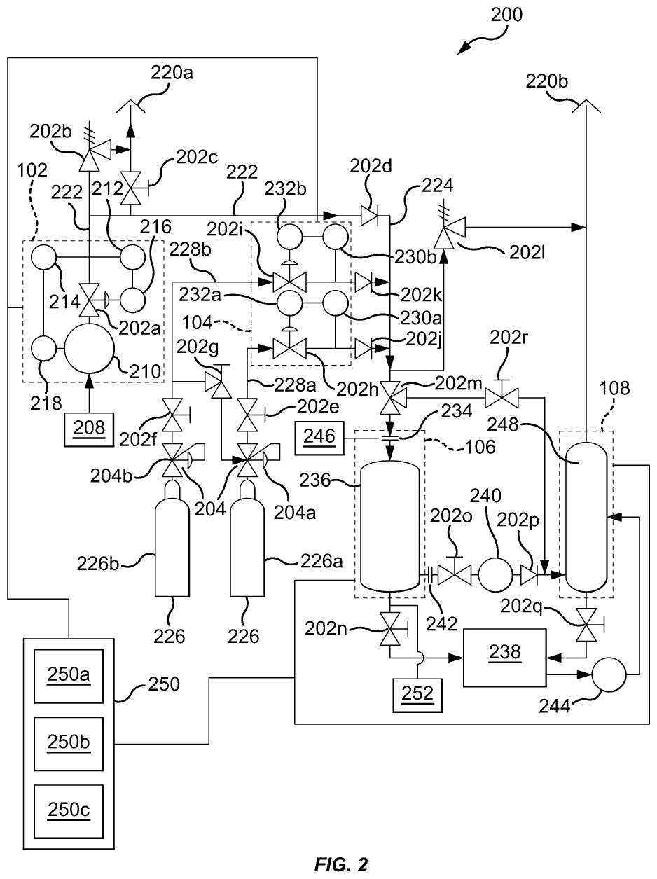

FIG. 2 illustrates an integrated system 200 designed for the purification of carbon nanotubes (CNTs). As discussed above, the integrated system 200 includes the four primary components (e.g., the steam generation unit 102, the gas supply unit 104, the purification/reaction unit 106, and the exhaust cleaning unit 108) coupled together via a series of valves, regulators, and/or pumps.

In some embodiments, the integrated system 200 includes a water source 208 coupled to the steam generation unit 102 via an inlet. The steam generation unit 102 may be configured to produce and/or supply steam to the integrated system 200 at predetermined flow rates and temperatures. The steam supplied by the steam generation unit 102 to the integrated system 200 can be used to heat the process lines thereof and/or aid in the CNT purification process. The steam generation unit 102 may be equipped with a heat exchanger 210 coupled to an outlet via a valve 202a, such as a diaphragm valve. In one embodiment, the steam generation unit 102 includes a flow indicator 212 and/or a temperature indicator 214 to determine the flow rate and/or temperature of the steam produced by the steam generation unit 102 and supplied to the integrated system 200 via the outlet of the steam generation unit 102. In some embodiments, the flow indicator 212 is in communication with a flow controller 216. The flow controller 216 may be connected to the valve 202a, wherein the connection between the flow controller 216 and the valve 202a is configured to adjust the flow rate of the steam produced by the steam generation unit 102 and supplied to the integrated system 200 to a desired and/or predetermined flow rate. The steam produced by the steam generation unit 102 may be supplied to the integrated system 200 at a flow rate of about 1 L/min to about 20 L/min, such as about 5 L/min to about 15 L/min, such as about 7.5 L/min to about 12.5 L/min, alternatively about 1 L/min to about 5 L/min, alternatively about 5 L/min to about 7.5 L/min, alternatively about 7.5 L/min to about 10 L/min, alternatively about 10 L/min to about 12.5 L/min, alternatively about 12.5 L/min to about 15 L/min, alternatively about 15 L/min to about 20 L/min. In some embodiments, the temperature indicator 214 is in communication with a temperature controller 218. The temperature controller 218 may be connected to the heat exchanger 210, wherein the connection between the temperature controller 218 and the heat exchanger 210 is configured to adjust the temperature of the steam produced by the steam generation unit 102 and supplied to the integrated system 200 to a desired and/or predetermined temperature. The steam produced by the steam generation unit 102 may be supplied to the integrated system 200 at a temperature of about 100° C. to about 1200° C., such as about 400° C. to about 800° C., such as about 500° C. to about 700° C., alternatively about 100° C. to about 400° C., alternatively about 400° C. to about 500° C., alternatively about 500° C. to about 600° C., alternatively about 600° C. to about 700° C., alternatively about 700° C. to about 800° C., alternatively about 800° C. to about 1200° C. Each of the flow indicator 212, flow controller 216, temperature indicator 214, and/or temperature controller 218 components can assist in providing and/or maintaining operational stability of the integrated system 200.

In some embodiments, the steam generation unit 102 is coupled to a process safety valve 202b, such as a pressure safety valve, connected to a vent 220a and/or an additional valve 202c. The process safety valve 202b may be integrated within the steam line 222 connecting the outlet of the steam generation unit 102 to one or more additional components within the integrated system 200. Integration of the process safety valve 202b can prevent overpressure scenarios, which may cause failure of one or more components of the integrated system 200. Additionally or alternatively, a non-return valve 202d is integrated within the steam line 222, downstream of the process safety valve 202b, separating the steam generation unit 102 from one or more additional components within the integrated system 200. The non-return valve 202d can prevent backflow of one or more process gases, and/or reaction products thereof, provided from one or more additional components within the integrated system 200 from reentering the steam line 222 and/or any component connected thereto. The non-return valve 202d may be configured to connect the steam line 222 with a process line 224.

In some embodiments, the gas supply unit 104 is coupled to the process line 224 at one or more locations. The gas supply unit 104 may be fluidly coupled with a gas supply cylinder 226. The gas supply cylinder 226 may be equipped with a regulator 204, such as a two-stage regulator, coupled to a valve connecting to the gas supply unit 104. The regulator 204 can control the flow rate and pressure of a gas flowing from the gas supply cylinder 226 to the gas supply unit 104. The gas supply unit 104 may be configured to supply a process gas to the integrated system 200 at a gas flow rate of about 0.001 L/min to about 15 L/min, such as about 0.01 L/min to about 12.5 L/min, such as about 0.1 L/min to about 10 L/min, such as about 1 L/min to about 5 L/min, alternatively about 0.001 L/min to about 0.01 L/min, alternatively about 0.01 L/min to about 0.1 L/min, alternatively about 0.1 L/min to about 1 L/min, alternatively about 1 L/min to about 2.5 L/min, alternatively about 2.5 L/min to about 5 L/min, alternatively about 5 L/min to about 10 L/min, alternatively about 10 L/min to about 12.5 L/min, alternatively about 12.5 L/min to about 15 L/min. The gas supply unit 104 may be configured to supply the process gas to the integrated system 200 at an operating pressure of about 5 barg or less, such as about 0.01 barg to about 5 barg, such as about 0.1 barg to about 4 barg, such as about 1 barg to about 3 barg, alternatively about 0.01 barg to about 0.1 barg, alternatively about 0.1 barg to about 1 barg, alternatively about 1 barg to about 2 barg, alternatively about 2 barg to about 3 barg, alternatively about 3 barg to about 4 barg, alternatively about 4 barg to about 5 barg. In some embodiments, the integrated system 200 integrates one or more process gases, such as a reactive gas (e.g., hydrogen and/or chlorine) and/or an inert gas (e.g., nitrogen, argon, and/or helium) into the process line 224 via the gas supply unit 104. The reactive gas may include one or more halogenated gases. The reactive gas may be provided to the gas supply unit 104 via a reactive gas cylinder 226a equipped with a regulator 204a. The regulator 204a may be coupled to a valve 202e that is connected to the gas supply unit 104, such that the reactive gas may flow from the reactive gas cylinder 226a to the gas supply unit 104 via a gas line 228a. The inert gas may be provided to the gas supply unit 104 via an inert gas cylinder 226b equipped with a regulator 204b. The regulator 204b may be coupled to a valve 202f that is connected to the gas supply unit 104, such that the inert gas may flow from the inert gas cylinder 226b to the gas supply unit 104 via a gas line 228b. In some embodiments, the gas line 228b is coupled with the regulator 204a via valve 202g, such that the reactive gas provided by the reactive gas cylinder 226a may be diluted with the inert gas provided by the inert gas cylinder 226b prior to entering the gas supply unit 104. In at least one embodiment, the inert gas provided by the inert gas cylinder 226b may be flown into the gas line 228a to purge the reactive gas therefrom.

The gas supply unit 104 may be configured to supply the inert gas to the integrated system 200 at a gas flow rate of about 0.001 L/min to about 10 L/min, such as about 0.001 L/min to about 7.5 L/min, such as about 0.01 L/min to about 5 L/min, such as about 0.1 L/min to about 2.5 L/min, alternatively about 0.001 L/min to about 0.01 L/min, alternatively about 0.01 L/min to about 0.1 L/min, alternatively about 0.1 L/min to about 1 L/min, alternatively about 1 L/min to about 2.5 L/min, alternatively about 2.5 L/min to about 5 L/min, alternatively about 5 L/min to about 7.5 L/min, alternatively about 7.5 L/min to about 10 L/min. The gas supply unit 104 may be configured to supply the inert gas to the integrated system 200 at an operating pressure of about 5 barg or less, such as about 0.01 barg to about 5 barg, such as about 0.1 barg to about 4 barg, such as about 1 barg to about 3 barg, alternatively about 0.01 barg to about 0.1 barg, alternatively about 0.1 barg to about 1 barg, alternatively about 1 barg to about 2 barg, alternatively about 2 barg to about 3 barg, alternatively about 3 barg to about 4 barg, alternatively about 4 barg to about 5 barg. The gas supply unit 104 may be configured to supply the reactive gas to the integrated system 200 at a gas flow rate of about 0.001 L/min to about 5 L/min, such as about 0.01 L/min to about 4 L/min, such as about 0.1 L/min to about 3 L/min, such as about 1 L/min to about 2 L/min, alternatively about 0.001 L/min to about 0.01 L/min, alternatively about 0.01 L/min to about 0.1 L/min, alternatively about 0.01 L/min to about 1 L/min, alternatively about 1 L/min to about 1.5 L/min, 1.5 L/min to about 2 L/min, alternatively about 2 L/min to about 3 L/min, alternatively about 3 L/min to about 4 L/min, alternatively about 4 L/min to about 5 L/min.

In some embodiments, the gas supply unit 104 is coupled to a gas line (e.g., gas line 228a and/or gas line 228b). The gas supply unit 104 may be equipped with a valve (e.g., valve 202h and/or valve 202i) to receive the gas line (e.g., gas line 228a and/or gas line 228b) via an inlet. The valve (e.g., valve 202h and/or valve 202i) may be connected to a non-return valve (e.g., non-return valve 202j and/or non-return valve 202k) via an outlet. The non-return valve (e.g., non-return valve 202j and/or non-return valve 202k) may be integrated into the process line 224, downstream of the gas supply unit 104, separating the gas supply unit 104 from one or more additional components within the integrated system 200. The non-return valve (e.g., non-return valve 202j and/or non-return valve 202k) can prevent backflow of one or more process gases, and/or reaction products thereof from reentering the gas line (e.g., gas line 228a and/or gas line 228b) and/or any component connected thereto. The non-return valve (e.g., non-return valve 202j and/or non-return valve 202k) may be configured to connect the gas supply unit 104 with the process line 224. The gas supply unit 104 may be configured to include a flow indicator (e.g., flow indicator 230a and/or flow indicator 230b) to determine the flow rate of the gas supplied by the gas supply unit 104 to the process line 224. In some embodiments, the flow indicator (e.g., flow indicator 230a and/or flow indicator 230b) is in communication with a flow controller (e.g., flow controller 232a and/or flow controller 232b). The flow controller (e.g., flow controller 232a and/or flow controller 232b) may be connected to the valve (e.g., valve 202h and/or valve 202i), wherein the connection between the two components may be configured to adjust the flow of the gas supplied by the gas supply unit 104 to the integrated system 200 to a desired and/or a predetermined flow rate.

In some embodiments, the gas supply unit 104 is coupled to a gas line 228a configured to supply a reactive gas and a gas line 228b configured to supply an inert gas thereto. The gas line 228a may be coupled to a valve 202h via an inlet. The valve 202h may be connected to a non-return valve 202j via an outlet. The non-return valve 202j may be integrated into the process line 224, downstream of the gas supply unit 104, separating the gas supply unit 104 from one or more additional components within the integrated system 200. The non-return valve 202j can prevent backflow of one or more process gases, and/or reaction products thereof from reentering the gas line 228a and/or any component connected thereto. The non-return valve 202j may be configured to connect the gas supply unit 104 with the process line 224. The gas supply unit 104 may be configured to include a flow indicator 230a to determine the flow rate of the gas supplied by the gas supply unit 104 via gas line 228a to the process line 224. In some embodiments, the flow indicator 230a is in communication with a flow controller 232a. The flow controller 232a may be connected to the valve 202h, wherein the connection between the two components may be configured to adjust the flow of the gas supplied by the gas supply unit 104 via gas line 228a to the integrated system 200 to a desired and/or a predetermined flow rate.

Additionally or alternatively, the gas line 228b may be coupled to a valve 202i via an inlet. The valve 202i may be connected to a non-return valve 202k via an outlet. The non-return valve 202k may be integrated into the process line 224, downstream of the gas supply unit 104, separating the gas supply unit 104 from one or more additional components within the integrated system 200. The non-return valve 202k can prevent backflow of one or more process gases, and/or reaction products thereof from reentering the gas line 228b and/or any component connected thereto. The non-return valve 202k may be configured to connect the gas supply unit 104 with the process line 224. The gas supply unit 104 may be configured to include a flow indicator 230b to determine the flow rate of the gas supplied by the gas supply unit 104 via gas line 228b to the process line 224. In some embodiments, the flow indicator 230b is in communication with a flow controller 232b. The flow controller 232b may be connected to the valve 202i, wherein the connection between the two components may be configured to adjust the flow of the gas supplied by the gas supply unit 104 via gas line 228b to the integrated system 200 to a desired and/or a predetermined flow rate.

In some embodiments, the process line 224 is coupled to a process safety valve 202l that is connected to a vent 220b. The process line 224 may also be connected a valve 202m, such as a three-way valve, that is coupled to the purification/reaction unit 106. The valve 202m at the inlet of the purification/reaction unit 106 can facilitate the bypass of the reaction vessel during maintenance and/or retrieval/loading of carbon nanomaterials. Additionally or alternatively, the valve 202m may be configured to permit steam circulation though the integrated system 200, when not in operation, to heat the components thereof to an operational temperature of about 100° C. to about 1200° C., such as about 400° C. to about 800° C., such as about 500° C. to about 700° C., alternatively about 100° C. to about 400° C., alternatively about 400° C. to about 500° C., alternatively about 500° C. to about 600° C., alternatively about 600° C. to about 700° C., alternatively about 700° C. to about 800° C., alternatively about 800° C. to about 1200° C. The purification/reaction unit 106 can include a purification zone 234 and a containment vessel 236. The process line 224 may be configured to transport a gas mixture of the steam from the steam generation unit 102 and the process gases from the gas supply unit 104 to the purification/reaction unit 106.

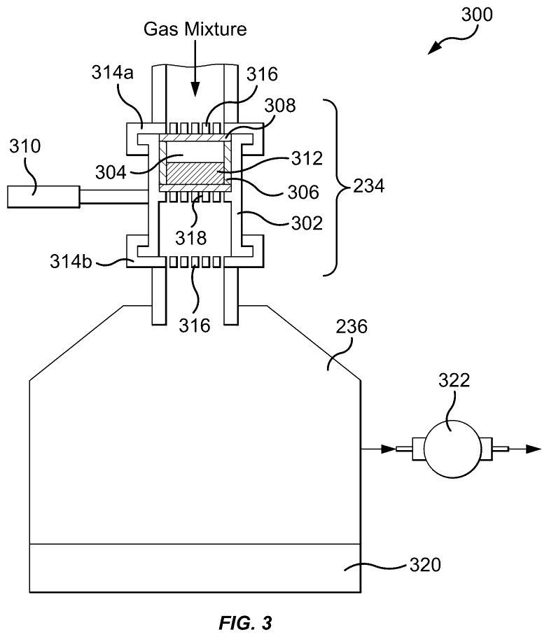

In one or more embodiments, the purification/reaction unit 106 can be further illustrated by the purification/reaction unit 300 shown in FIG. 3. As shown in FIG. 3, the purification/reaction unit 300 includes the purification zone 234. The purification zone 234 includes a reaction vessel 302 equipped with a purification chamber 304 having a chemical-resistant interior 306 and one or more felt filter elements 308, such as a graphite felt filter element. In at least one embodiment, a graphite felt filter element includes a porous carbon paper. The porous carbon paper may be affixed to a side of the felt filter element, such that the carbon paper is in contact with the material being purified within the reaction vessel 302. The reaction vessel 302 may include a dual-shell container having an outer shell and/or an inner lining. The outer shell may be composed of nickel, stainless steel, tungsten, or a combination thereof. In at least one embodiment, the outer shell is composed of tungsten. The inner lining forms the chemical-resistant interior 306 and may be composed of graphite, tungsten, polytetrafluoroethylene (PTFE), or a combination thereof. In at least one embodiment, the inner lining is composed of graphite. In some embodiments, the reaction vessel 302 is configured to be removed from the purification zone 234 via a removable locking mechanism 310. The reaction vessel 302 may be manually removed or removed via a robotic component 246, such as a robotic arm or end effector. Removal of the reaction vessel 302 enables loading and recovery of carbon nanomaterials 312. During operation of the integrated system 200, the reaction vessel 302 is locked within the purification zone 234 via an upper break flange 314a and a lower break flange 314b. Each of the upper break flange 314a and the lower break flange 314b can include a fritted membrane 316 that is configured to allow the gas mixture from the process line 224 to pass there through while also preventing passage of particulates there through. The reaction vessel may also include a fritted membrane 318 that is configured to retain the carbon nanomaterials 312 during operation of the integrated system 200, wherein the gas mixture from the process line 224 is flowed through the reaction vessel 302 and the carbon nanomaterials 312. The purification/reaction unit 300 may also include the containment vessel 236 wherein a condensate 320 may be collected as a result of the removal of one or more impurities from the carbon nanomaterials 312 during operation of the integrated system 200. The containment vessel 236 may also be equipped with a pump 322 to remove the remaining gas mixture therefrom during operation of the integrated system 200. The pump 322 may be configured and/or positioned to enhance extraction and filtration of the gas mixture from the process line 224 through the felt filter elements 308 during operation. In some embodiments, a gas analysis system 252 may be coupled to the line (e.g., a drain line) between the purification/reaction unit 106 and the drain valve 202n to analyze the condensate being removed from the containment vessel 236. The gas analysis system may be configured to detect the presence of the process gas provided by the gas supply unit 104 and/or the impurity within the carbon nanomaterials 312 to determine the extent to which the carbon nanomaterials 312 are cleaned during operation of the purification/reaction unit 106.

Referring back to FIG. 2, the containment vessel 236 may be connected to a collection tank 238 via a drain valve 202n. The drain valve 202n may be positioned such that the condensate 320 within the containment vessel 236 may be removed therefrom and/or flowed into the collection tank 238. In some embodiments, the pump 322 (shown as pump 240 in FIG. 2) is configured to be coupled to the containment vessel 236 and may be separated therefrom via a break flange 242 and/or a valve 2020. The break flange 242 may be configured to include a removable gas scrubber apparatus configured to, at least, partially remove the remaining reactive gas within the gas mixture of the process line 224 contained within the headspace of the containment vessel 236 upon operation of the integrated system 200. The pump 240 may be configured to facilitate removal of the gas mixture from the containment vessel 236 through a non-return valve 202p, the non-return valve 202p being coupled to the pump 240, to the exhaust cleaning unit 108. In some embodiments, the gas mixture removed from the headspace of the containment vessel 236 may be recirculated to the purification/reaction unit 106 via a valve 202r.

The exhaust cleaning unit 108 may include a gas scrubber apparatus 248 configured to substantially remove any remaining reactive gas from the gas mixture transported thereto from the containment vessel 236 during operation of the integrated system 200, such that the gas exiting from the exhaust cleaning unit 108 and through vent 220b is substantially composed of the inert gas. In some embodiments, the exhaust cleaning unit 108 is equipped with one or more gas filter/scrubber components. The one or more gas filter/scrubber components may include a desiccant, such as activated alumina and/or activated carbon. The desiccant may be impregnated with a reagent to enhance its reactive gas removal capacity. Additionally or alternatively, the exhaust cleaning unit 108 may include an absorbent fluid circulation unit configured to introduce a scrubber fluid thereto to substantially remove the reactive gas from the gas mixture. The scrubber fluid may include an aqueous solution having a component (e.g., potassium permanganate or other suitable material) capable of reacting with the reactive gas to form a salt therefrom. The salt may be removed from the exhaust cleaning unit 108 via drain valve 202q and collected in the collection tank 238. In some embodiments, the components within the collection tank 238 may be recirculated into the absorbent fluid circulation unit of the exhaust cleaning unit 108 via a pump 244.

In some embodiments, the integrated system 200 may also include a controller 250. The controller 250 may independently control one or more components and/or operations of the integrated system 200 (e.g., the steam generation unit 102, the gas supply unit 104, the purification/reaction unit 106, and/or the exhaust cleaning unit 108). The controller 250 can be any type of controller used in an industrial setting, such as a programmable logic controller (PLC). The controller 250 includes a processor 250a, a memory 250b, and input/output (I/O) circuits 250c. The controller 250 can further include one or more of the following components, such as one or more power supplies, clocks, communication components (e.g., network interface card), and user interfaces typically found in controllers for semiconductor equipment. The memory 250b can include non-transitory memory. The non-transitory memory can be used to store the programs and settings described below. The memory 250b can include one or more readily available types of memory, such as read only memory (ROM) (e.g., electrically erasable programmable read-only memory), flash memory, floppy disk, hard disk, or random access memory (RAM) (e.g., non-volatile random access memory).

In some embodiments, the controller 250 may be configured to execute and/or initiate a process, such as operating and/or controlling one or more operations of the integrated system 200. The process may be executed so as to prepare cleaned carbon nanomaterials (e.g., carbon nanomaterials having 1 wt % or less of catalyst). In some embodiments, the controller 250 may be configured to initiate a preheat sequence wherein one or more components of the integrated system 200 are heated to an operational temperature. In some embodiments, the controller 250 may be configured to execute a system blowdown operation to remove contaminants from one or more components of the integrated system. In some embodiments, the controller 250 may be configured to instruct a robotic component 246 to remove the reaction vessel 302 from the purification zone 234 via the removable locking mechanism 310 and/or load the reaction vessel 302 with carbon nanomaterials 312 (e.g., carbon nanotubes). In some embodiments, the carbon nanomaterials 312 loaded within the reaction vessel 302 include one or more impurities (e.g., a catalyst impurity) within its composition as a result of their synthesis and/or preparation. The controller 250 may also be configured to instruct the robotic component 246 to dock the reaction vessel 302 in the purification zone 234, such that the reaction vessel 302 forms a hermetic seal with the upper break flange 314a and the lower break flange 314b to maintain specified operational pressures. In some embodiments, the controller 250 is configured to rapidly elevate the temperature of the reaction vessel 302 to an operational temperature. In some embodiments, the controller 250 is configured to initiate operation of the steam generation unit 102 to provide steam to one or more of the components of the integrated system 200. In some embodiments, the controller 250 is configured to execute operation of the gas supply unit 104 to provide one or more process gases to one or more components of the integrated system 200. The steam generated via operation of the steam generation unit 102 and the process gases provided via operation of the gas supply unit 104 may be combined in the gas line 228b and form a gas mixture. In some embodiments, the controller 250 is configured to execute operation of the purification/reaction unit 106 (e.g., perform a purification operation) to pass the gas mixture through the reaction vessel 302 to remove one or more impurities from the carbon nanomaterials 312. In some embodiments, the controller 250 is configured to execute operation of the exhaust cleaning unit 108 to remove the waste gas from the purification/reaction unit 106, produced via operation thereof, and substantially remove the reactive gas component therefrom. In some embodiments, the controller 250 is configured to initiate a final system blowdown operation to clean the integrated system 200 after operation thereof. The controller 250 may be configured to execute one or more of the operations sequentially, concurrently, or continuously.

As previously discussed, the steam generated via operation of the steam generation unit 102 and the process gases provided via operation of the gas supply unit 104 may be combined in the gas line 228b and form a gas mixture. The gas mixture may be flown through the reaction vessel 302 of the purification/reaction unit 106 to remove the impurity from the carbon nanomaterials 312 therein. As the gas mixture passes through the reaction vessel 302, the reactive gas, provided to the gas mixture via the gas supply unit 104, reacts with the impurity of the carbon nanomaterials 312 to form a complex, which then can be removed from the reaction vessel 302. The complex may be soluble in the gas mixture being passed through the reaction vessel 302, such that the complex passes there through with the gas mixture into the containment vessel 236 and is collected within the condensate 320. During operation, the gas mixture supplied to the purification/reaction unit 106 may provide an operating pressure thereto of about 5 barg or less, such as about 0.01 barg to about 5 barg, such as about 0.1 barg to about 4 barg, such as about 1 barg to about 3 barg, alternatively about 0.01 barg to about 0.1 barg, alternatively about 0.1 barg to about 1 barg, alternatively about 1 barg to about 2 barg, alternatively about 2 barg to about 3 barg, alternatively about 3 barg to about 4 barg, alternatively about 4 barg to about 5 barg.

In some embodiments, the carbon nanomaterials 312 are loaded into the purification chamber 304 of the reaction vessel 302 using a sufficient force to ensure that the gas mixture is able to permeate there through without disrupting the global configuration of the carbon nanomaterials 312 (e.g., forming a dust via perturbation of the global configuration of the carbon nanomaterials 312). As such, the carbon nanomaterials 312 may be loaded into the purification chamber 304 of the reaction vessel 302, either manually or via a robotic component, using a sufficient force to form a puck therefrom. The carbon nanomaterials 312 may be loaded into the purification chamber 304 via any suitable method known to one of ordinary skill in the art, such as tamping. In some embodiments, the carbon nanomaterials 312 may be sprayed with a water soluble solvent (e.g., ethanol) to assist in loading the carbon nanomaterials 312 into the purification chamber 304.

The carbon nanomaterials 312 may be loaded into the purification chamber 304 using a suitable force to form a puck from the carbon nanomaterials 312 within the purification chamber 304, such as about 0.1 N to about 100 N, such as about 1 N to about 50 N, such as about 5 N to about 25 N, alternatively about 0.1 N to about 1 N, alternatively about 1 N to about 5 N, alternatively about 5 N to about 10 N, alternatively about 10 N to about 15 N, alternatively about 15 N to about 25 N, alternatively about 25 N to about 50 N, alternatively about 50 N to about 100 N. The puck may have a suitable density of carbon nanomaterials 312 contained therein, such that the puck retains its shape (e.g., a de minimus reduction in the concentration of carbon nanomaterials 312 contained within the puck) during operation of the integrated system 200. Additionally or alternatively, the puck may have a suitable porosity so as to allow the process gas to flow there through during operation of the integrated system 200. As previously discussed, the progression of the gas mixture through the reaction vessel 302 occurs at operating pressure of about 0.01 barg to about 5 barg. In some embodiments, the puck within the purification chamber 304 may provide a back pressure to the integrated system 200. The back pressure may be less than the operating pressure.

In some embodiments, the carbon nanomaterials 312 include carbon nanomaterials taken directly from (e.g., in a continuous manner concurrently with the synthesis of carbon nanomaterials) a system or apparatus from which they were prepared. The carbon nanomaterials 312 may be loaded into the reaction vessel 302 in an as-formed composition or subsequent an additional processing operation. In one or more embodiments, the carbon nanomaterials 312 are formed from waste plastics, waste solvents, and combinations thereof. In at least one embodiment, the carbon nanomaterials 312 are formed from one or more hydrocarbon materials. The carbon nanomaterials 312 may include carbon nanotubes, such as single-walled carbon nanotubes, few-walled carbon nanotubes, multi-walled carbon nanotubes, and combinations thereof. In some embodiments, the carbon nanomaterials 312 are in the form of a powder, a film, or a combination thereof. In some embodiments, the carbon nanomaterials 312 include Buckypaper.

As previously discussed, the carbon nanomaterials 312 loaded within the reaction vessel 302 have one or more impurities within its composition as a result of their synthesis and/or preparation. In some embodiments, the one or more impurities include the catalyst compound used to form the carbon nanomaterials 312. The impurity may include one or more of iron, cobalt, nickel, molybdenum, copper, chromium, palladium, platinum, ruthenium, rhodium, iron-cobalt, iron-nickel, iron-molybdenum, nickel-molybdenum, cobalt-molybdenum, iron-copper, nickel-copper, silicon dioxide, aluminum oxide, magnesium oxide, zeolites, graphene oxide, activated carbon, calcium carbonate, silicon carbide, ferrocene, cobaltocene, nickelocene, iron nitrate, iron acetate, cobalt acetate, molybdenum acetate, nickel acetate, iron oxalate, cobalt oxalate, nickel oxalate, iron pentacarbonyl, ferric oleate, molybdenum carbide, iron carbide, lanthanum ferrite, metal-organic frameworks, vanadium nitride, iron nitride, or a compound derived therefrom.

As previously discussed, the gas supply unit 104 is configured to provide a process gas to the integrated system 200. The process gas can include an inert gas and/or a reactive gas. In some embodiments, the inert gas is composed of nitrogen, argon, helium, or a combination thereof. In some embodiments, the reactive gas includes chlorine gas and/or a chlorine-based gas. The process gas may be provided to the integrated system 200 via the gas supply unit 104 at a suitable flow rate, pressure, and/or temperature to sufficiently remove the impurity from the carbon nanomaterial 312, as instructed by the controller 250. Additionally or alternatively, the steam provided to the integrated system 200 via the steam generation unit 102 may be supplied at a suitable flow rate, pressure, and/or temperature to sufficiently remove the impurity from the carbon nanomaterial 312, as instructed by the controller 250. In some embodiments, operation of the integrated system 200 can produce carbon nanomaterials 312 having an impurity content of about 10 wt % or less, such as about 5 wt % or less, such as about 1 wt % or less, such as about 0.1 wt % or less.

As previously discussed, the reactive gas, provided to the gas mixture via the gas supply unit 104, reacts with the impurity of the carbon nanomaterials 312 to form a complex, which then can be removed from the reaction vessel 302. In some embodiments, the complex is a chlorine-metal complex (e.g., iron-chloride). In some embodiments, the complex is soluble in an aqueous environment, such as the gas mixture supplied to the reaction vessel.

The present disclosure provides a system by which a wide range of carbon allotrope nanomaterials may be processed into high-quality nanotubes having lower or no catalyst content. An object of the present disclosure is to provide an apparatus in which carbon nanotubes may be purified and treated, in which the use of this apparatus is advantageous for increasing their conductivity, increasing their material properties such as quality as measured by their G/D spectral peaks, increasing their applicability for various industries, and preventing release of errant metal particles, amorphous carbon, or other additional carbons that exist as by-products of the CNT production process.

Another object of the present disclosure is to provide an apparatus suitably adapted for processing of alternative carbon nanomaterials within the cleaning apparatus that cannot otherwise be treated using conventional techniques. Yet another object of the present disclosure is to provide a rapid and low-cost apparatus for making high-quality/low-impurity CNT products. The present disclosure provides apparatus that enables a single-step process to purify raw carbon nanotubes, which is simple, safe and scalable.

By avoiding the need for solvent preparation and or dispersion, an operator can avoid the need for post water rinsing that can require large volumes of water, which is a precious resource. Thus, saving time, resources, and energy that would otherwise be required to prepare the carbon nanomaterials. Avoiding the use of solvents prevents the need to later remove the solvent materials from the purified samples. Liquid acids can affect the electrical conductivity of the nanotubes thereafter and they can create challenges in plastic forming in the case of composite manufacturing. Furthermore, they can become gaseous once heated, and so discharge a vapor that may be harmful or dangerous to the environment or the user.

The method and apparatus described herein enable a robust, safety-enhanced system capable of efficiently purifying carbon nanotubes while managing and mitigating environmental and safety risks associated with the handling and disposal of reactive and hazardous materials. The method described herein involves processing carbon nanomaterials (e.g., carbon nanotubes), either purchased or made synthetically, and pressing them into the reaction vessel and applying a set of relevant process conditions to clean such materials. The method described herein is not limited to the use of single walled or multi-walled carbon nanotubes. Other carbon nanomaterials can be used, such as single walled carbon nanotube, vapor grown fibers, Buckminster fullerenes, and combinations thereof. Furthermore, the present apparatus enables processing of other non-carbon nanomaterials to be added in addition to or without the presence of the carbon nanomaterials. Because this system enables a solvent free process, it can be suitable for rapid deployment in electrification applications. This can be done in a continuous method directly as nanotubes are manufactured, which is beneficial for large-scale operations.

### EMBODIMENTS LISTING

Clause 1. An apparatus for cleaning carbon nanomaterials, the apparatus comprising:
a steam generation unit configured to provide steam via a gas line at a flow rate of about 0.001 L/min to about 10 L/min;
a gas supply unit configured to provide a process gas to the gas line at a flow rate of about 0.001 L/min to about 15 L/min;
a purification/reaction unit comprising a reaction vessel, wherein:
   the purification/reaction unit is coupled with the gas line to flow the steam and the process gas through the reaction vessel, and
   the reaction vessel is removably coupled with purification/reaction unit, the reaction vessel comprising:
      an outer shell,
      a chemical-resistant interior, and
   a felt filter element; and
an exhaust gas cleaning unit.

Clause 2. The apparatus of clause 1, wherein the outer shell comprises nickel, stainless steel, tungsten, or a combination thereof.

Clause 3. The apparatus of any clauses 1-2, wherein the chemical-resistant interior comprises an inner lining, the inner lining comprising graphite, tungsten, polytetrafluoroethylene (PTFE), or a combination thereof.

Clause 4. The apparatus of any clauses 1-3, wherein the reaction vessel is locked within a purification zone of the purification/reaction unit via an upper break flange and a lower break flange.

Clause 5. The apparatus of clause 4, wherein at least one of the upper break flange or the lower break flange comprises a fritted membrane.

Clause 6. The apparatus of any clauses 1-5, wherein the reaction vessel comprises a fritted membrane.

Clause 7. The apparatus of any clauses 1-6, wherein the felt filter element comprises a graphite felt filter element.

Clause 8. The apparatus of clauses 1-7, wherein reaction vessel further comprises a carbon nanomaterial puck housed within a purification zone of the reaction vessel.

Clause 9. The apparatus of any clauses 1-8, wherein the apparatus further comprises a controller configured to execute a process, the process comprising:
initiating a preheat sequence,
executing a system blowdown operation to remove contaminants from the apparatus,
introducing carbon nanomaterials to the reaction vessel, the carbon nanomaterials comprising an impurity,
initiating operation of the steam generation unit to provide a steam to the reaction vessel,
initiating operation of the gas supply unit to provide a process gas to the reaction vessel, and
initiating operation of the purification/reaction unit to flow the steam and the process gas through the reaction vessel to remove the impurity from the carbon nanomaterials.

Clause 10. An apparatus for cleaning carbon nanomaterials, the apparatus comprising:
a steam generation unit configured to provide steam via a gas line at a temperature of about 100° C. to about 1200° C.;
a gas supply unit configured to provide a process gas to the gas line at an operating pressure of about 5 barg or less;
a purification/reaction unit comprising a reaction vessel, wherein:
   the purification/reaction unit is coupled with the gas line to flow the steam and the process gas through the reaction vessel, and
   the reaction vessel is removably coupled with purification/reaction unit, the reaction vessel comprising:
      an outer shell,
      a chemical-resistant interior,
      a felt filter element, and
      an exhaust gas cleaning unit; and
a controller, wherein the controller is configured to execute a process comprising:
   executing a system blowdown operation to remove contaminants from the apparatus,
   introducing carbon nanomaterials to the reaction vessel, the carbon nanomaterials comprising an impurity,
   initiating operation of the steam generation unit to provide a steam to the reaction vessel,
   initiating operation of the gas supply unit to provide a process gas to the reaction vessel, the process gas comprising chlorine gas, and
   initiating operation of the purification/reaction unit to flow the steam and the process gas through the reaction vessel to form a complex between the impurity and the chlorine gas, wherein the complex is soluble in an aqueous environment.

Clause 11. The apparatus of clause 10, wherein the impurity comprises a catalyst compound used to form the carbon nanomaterials.

Clause 12. The apparatus of any clauses 10-11, wherein the impurity is selected from the group consisting of iron, cobalt, nickel, molybdenum, copper, chromium, palladium, platinum, ruthenium, rhodium, iron-cobalt, iron-nickel, iron-molybdenum, nickel-molybdenum, cobalt-molybdenum, iron-copper, nickel-copper, silicon dioxide, aluminum oxide, magnesium oxide, zeolites, graphene oxide, activated carbon, calcium carbonate, silicon carbide, ferrocene, cobaltocene, nickelocene, iron nitrate, iron acetate, cobalt acetate, molybdenum acetate, nickel acetate, iron oxalate, cobalt oxalate, nickel oxalate, iron pentacarbonyl, ferric oleate, molybdenum carbide, iron carbide, lanthanum ferrite, metal-organic frameworks, vanadium nitride, iron nitride, and combinations thereof.

Clause 13. The apparatus of any clauses 10-12, wherein the carbon nanomaterials comprise materials formed from waste plastics, waste solvents, or a combination thereof.

Clause 14. The apparatus of any clauses 10-13, wherein the carbon nanomaterials comprise single walled carbon nanotubes, few-walled carbon nanotubes, multi-walled carbon nanotubes, and combinations thereof.

Clause 15. An apparatus for cleaning carbon nanomaterials, the apparatus comprising:
a purification/reaction unit, the purification/reaction unit comprising a removable reaction vessel, the removable reaction vessel comprising:
   an outer shell,
   a chemical-resistant interior, and
   a felt filter element;
a steam generation unit coupled to the purification/reaction unit via a gas line configured to flow a gas through the removable reaction vessel;
a gas supply unit coupled to the purification/reaction unit via the gas line; and
an exhaust cleaning unit coupled to the purification/reaction unit.

Clause 16. The apparatus of clause 15, wherein the steam generation unit is configured to supply a steam to through removable reaction vessel via the gas line at a flow rate of about 0.001 L/min to about 10 L/min.

Clause 17. The apparatus of any clauses 15-16, wherein the gas supply unit is configured to supply a process gas to through removable reaction vessel via the gas line at a flow rate of about 0.001 L/min to about 15 L/min.

Clause 18. The apparatus of any clauses 15-17, wherein the purification/reaction unit is configured to flow a gas mixture through the reaction vessel to form a waste stream, the waste stream comprising:
a steam supplied by the steam generation unit,
a process gas supplied by the gas supply unit, wherein the process gas comprises a reactive gas, and
a chlorine-metal complex.

Clause 19. The apparatus of clause 18, wherein the exhaust cleaning unit is configured to remove the reactive gas from the waste stream.

Clause 20. The apparatus of any clauses 15-19, the apparatus further comprising a collection tank coupled to the purification/reaction unit and the exhaust cleaning unit.

Certain embodiments of this disclosure are not limited to any particular individual feature disclosed here but include combinations of them distinguished from the prior art in their structures, functions, and/or results achieved. Features of the disclosure have been broadly described so that the detailed descriptions that follow may be better understood, and in order that the contributions of this disclosure to the arts may be better appreciated.

There are, of course, additional aspects of the disclosure described below, and which may be included in the subject matter of the claims to this disclosure. Those skilled in the art who have the benefit of this disclosure, its teachings, and suggestions will appreciate that the conceptions of this disclosure may be used as a creative basis for designing other structures, methods and systems for carrying out and practicing the methods described herein. The claims of this disclosure are to be read to include any legally equivalent apparatus or methods, which do not depart from the spirit and scope of the present disclosure. The present disclosure and its diverse embodiments recognize and address the long-felt needs and provides a solution to problems and a satisfactory meeting of those needs in its various possible embodiments and equivalents thereof. To one of skill in this art who has the benefits of this disclosure's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this disclosure no matter how others may later disguise it by variations in form, changes, or additions of further improvements.

It will be understood that the various embodiments of the present disclosure may include one, some, or any possible combination of the disclosed, described, and/or enumerated features, aspects, and/or improvements and/or technical advantages and/or elements in claims to this disclosure.

As can be easily understood from the foregoing, the basic concepts of the present disclosure may be embodied in a variety of ways. It involves structures, method steps, and techniques as well as apparatus to accomplish the appropriate ends. Techniques and method steps according to the present disclosure are disclosed as part of the results shown to be achieved by the various apparatus and structures and described as steps, which are inherent to utilization and are simply the natural result of utilizing the apparatus and structures as intended and described. In addition, while some apparatus and structures are disclosed, it should be understood that these not only accomplish certain methods but also can be varied in a number of ways. As to all of the foregoing, all of these facets should be understood as encompassed by this disclosure.

While the foregoing is directed to embodiments of the present disclosure, other and further embodiments of the disclosure may be devised without departing from the basic scope thereof, and the scope thereof is determined by the claims that follow.

1. An apparatus for cleaning carbon nanomaterials, the apparatus comprising:
a steam generation unit configured to provide steam via a gas line at a flow rate of about 0.001 L/min to about 10 L/min;
a gas supply unit configured to provide a process gas to the gas line at a flow rate of about 0.001 L/min to about 15 L/min;
a purification/reaction unit comprising a reaction vessel, wherein:
the purification/reaction unit is coupled with the gas line and configured to flow the steam and the process gas through the reaction vessel, and
the reaction vessel is removably coupled with purification/reaction unit, the reaction vessel comprising:
an outer shell,
a chemical-resistant interior, and
a felt filter element; and
an exhaust gas cleaning unit.

2. The apparatus of claim 1, wherein the outer shell comprises nickel, stainless steel, tungsten, or a combination thereof.

3. The apparatus of claim 1, wherein the chemical-resistant interior comprises an inner lining, the inner lining comprising graphite, tungsten, polytetrafluoroethylene (PTFE), or a combination thereof.

4. The apparatus of claim 1, wherein the reaction vessel is locked within a purification zone of the purification/reaction unit via an upper break flange and a lower break flange.

5. The apparatus of claim 4, wherein at least one of the upper break flange or the lower break flange comprises a fritted membrane.

6. The apparatus of claim 1, wherein the reaction vessel comprises a fritted membrane.

7. The apparatus of claim 1, wherein the felt filter element comprises a graphite felt filter element.

8. The apparatus of claim 1, wherein reaction vessel further comprises a carbon nanomaterial puck housed within a purification zone of the reaction vessel.

9. The apparatus of claim 1, wherein the apparatus further comprises a controller configured to execute a process, the process comprising:
initiating a preheat sequence,
executing a system blowdown operation to remove contaminants from the apparatus,
introducing carbon nanomaterials to the reaction vessel, the carbon nanomaterials comprising an impurity,
initiating operation of the steam generation unit to provide a steam to the reaction vessel,
initiating operation of the gas supply unit to provide a process gas to the reaction vessel, and
initiating operation of the purification/reaction unit to flow the steam and the process gas through the reaction vessel to remove the impurity from the carbon nanomaterials.

10. An apparatus for cleaning carbon nanomaterials, the apparatus comprising:
a steam generation unit configured to provide steam via a gas line at a temperature of about 100° C. to about 1200° C.;
a gas supply unit configured to provide a process gas to the gas line at an operating pressure of about 5 barg or less;
a purification/reaction unit comprising a reaction vessel, wherein:
the purification/reaction unit is coupled with the gas line and configured to flow the steam and the process gas through the reaction vessel; and
the reaction vessel is removably coupled with purification/reaction unit, the reaction vessel comprising:
an outer shell,
a chemical-resistant interior;
a felt filter element;
an exhaust gas cleaning unit; and
a controller, wherein the controller is configured to execute a process comprising:
executing a system blowdown operation to remove contaminants from the apparatus;
introducing carbon nanomaterials to the reaction vessel, the carbon nanomaterials comprising an impurity;
initiating operation of the steam generation unit to provide a steam to the reaction vessel;
initiating operation of the gas supply unit to provide a process gas to the reaction vessel, the process gas comprising chlorine gas; and
initiating operation of the purification/reaction unit to flow the steam and the process gas through the reaction vessel to form a complex between the impurity and the chlorine gas, wherein the complex is soluble in an aqueous environment.

11. The apparatus of claim 10, wherein the impurity comprises a catalyst compound used to form the carbon nanomaterials.

12. The apparatus of claim 11, wherein the impurity is selected from the group consisting of iron, cobalt, nickel, molybdenum, copper, chromium, palladium, platinum, ruthenium, rhodium, iron-cobalt, iron-nickel, iron-molybdenum, nickel-molybdenum, cobalt-molybdenum, iron-copper, nickel-copper, silicon dioxide, aluminum oxide, magnesium oxide, zeolites, graphene oxide, activated carbon, calcium carbonate, silicon carbide, ferrocene, cobaltocene, nickelocene, iron nitrate, iron acetate, cobalt acetate, molybdenum acetate, nickel acetate, iron oxalate, cobalt oxalate, nickel oxalate, iron pentacarbonyl, ferric oleate, molybdenum carbide, iron carbide, lanthanum ferrite, metal-organic frameworks, vanadium nitride, iron nitride, and combinations thereof.

13. The apparatus of claim 10, wherein the carbon nanomaterials comprise materials formed from waste plastics, waste solvents, or a combination thereof.

14. The apparatus of claim 10, wherein the carbon nanomaterials comprise single walled carbon nanotubes, few-walled carbon nanotubes, multi-walled carbon nanotubes, and combinations thereof.

15. An apparatus for cleaning carbon nanomaterials, the apparatus comprising:
a purification/reaction unit, the purification/reaction unit comprising a removable reaction vessel, the removable reaction vessel comprising:
an outer shell;
a chemical-resistant interior; and
a felt filter element;
a steam generation unit coupled to the purification/reaction unit via a gas line configured to flow a gas through the removable reaction vessel;
a gas supply unit coupled to the purification/reaction unit via the gas line; and
an exhaust cleaning unit coupled to the purification/reaction unit.

16. The apparatus of claim 15, wherein the steam generation unit is configured to supply steam through the removable reaction vessel via the gas line at a flow rate of about 0.001 L/min to about 10 L/min.

17. The apparatus of claim 15, wherein the gas supply unit is configured to supply a process gas through the removable reaction vessel via the gas line at a flow rate of about 0.001 L/min to about 15 L/min.

18. The apparatus of claim 15, wherein the purification/reaction unit is configured to flow a gas mixture through the reaction vessel to form a waste stream, the waste stream comprising:
a steam supplied by the steam generation unit;
a process gas supplied by the gas supply unit, wherein the process gas comprises a reactive gas; and
a chlorine-metal complex.

19. The apparatus of claim 18, wherein the exhaust cleaning unit is configured to remove the reactive gas from the waste stream.

20. The apparatus of claim 15, the apparatus further comprising a collection tank coupled to the purification/reaction unit and the exhaust cleaning unit.
